(19) United States
(12) Patent Application Publication
(10) Pub. No.: US 2024/0404135 A1
(43) Pub. Date: Dec. 5, 2024

(54) Visualizing and Filtering Graph Data

(71) Applicant: Oracle International Corporation, Redwood Shores, CA (US)

(72) Inventor: Saju ASOKAN, Trivandrum (IN)

(21) Appl. No.: 18/327,264

(22) Filed: Jun. 1, 2023

(51) Int. Cl. G06T 11/20

(52) U.S. Cl. CPC G06T 11/206

(57) ABSTRACT

Embodiments visualize graph data including vertices interconnected by edges. Embodiments receive a selection of a source vertex and generate a filtered layer corresponding to a filter condition relative to the source vertex. Embodiments automatically place a plurality of vertices that correspond to the filter condition on the filtered layer.

### FIELD

One embodiment is directed generally to graphing data, and in particular to visualizing and filtering graph data using a computer system.

### BACKGROUND INFORMATION

A graph is an effective tool for visualizing relationships between data entities. By representing data entities as vertices and their fine-grained interconnections as edges, a graph visualization provides users with a quick and intuitive understanding of the dataset. However, the effectiveness of graph visualization degrades as the size of a data set grows to the point that there are too many vertices and edges to clearly visualize.

Once the amount of data becomes larger than some threshold, occlusion and data density become too high for an effective visualization. Specifically, the vertices and edges overlap extensively, and therefore the user is overwhelmed by the volume of information, rather than being given a well-summarized understanding. Consequently, graph visualization has had limited success in visualizing very large data sets.

There have been some approaches to resolve the large graph visualization problem, most prominently pan-and-zoom, clustering/communities, and a hyperbolic fish eye. Pan and zoom is one way the user can explore large graphs. However, the user sees just a part of the graph when zooming in, instead of getting an overview of all the information in the graph. Communities group vertices of a graph into sets, such that each set is densely connected internally. Each group/set can be visually distinguished (e.g., different color, size, shape), and the vertices that belong to a group can be visualized closer together. In the fish-eye view, the selected area is magnified and the surrounding areas are distorted (shrunk) to remain in view.

In general, known large graph visualization methods focus on visualizing each vertex and edge and may offer techniques to hide parts of the graph or summarize communities based on topology.

### SUMMARY

Embodiments visualize graph data including vertices interconnected by edges. Embodiments receive a selection of a source vertex and generate a filtered layer corresponding to a filter condition relative to the source vertex. Embodiments automatically place a plurality of vertices that correspond to the filter condition on the filtered layer.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 is an visualization of graph data in accordance to embodiments of the invention.

FIG. 2 is an visualization of graph data in accordance to embodiments of the invention.

FIG. 3 is an visualization of graph data in accordance to embodiments of the invention.

FIG. 4 is an visualization of graph data in accordance to embodiments of the invention.

FIG. 5 is a flow diagram of a process for visualizing and filtering graph data for a graph that includes vertices and edges in accordance to embodiments.

FIG. 6 is a block diagram of a computer server/system in accordance with an embodiment of the present invention that can be used to implement any of the functionality disclosed herein.

### DETAILED DESCRIPTION

One embodiment displays graph data as layers, where each layer corresponds to a filtered criteria. All vertices that correspond to a layer are visually placed on the layer, and additional layers can be easily spawned. The automatic pulling of vertices to the respective layers alleviates the large graph visualization problem.

As disclosed, in conventional two dimensional (“2D”) graph visualizations, segregating vertices into categories (e.g., finding vertices that are “n” hop counts away from a particular vertex), is not easy when the graph has hundreds or thousands of vertices. One known solution is color coding by assigning specific colors to each edge based on its distance from the source vertex and showing the colors in a legend. Another known solution is to have heat maps where a color gradient changes from deeper shades to lighter, or transparency, as edges move farther from the source vertex. However, as vertex counts exceed a threshold, locating the vertices of identical colors or gradients from among the other hundreds or thousands can be challenging.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

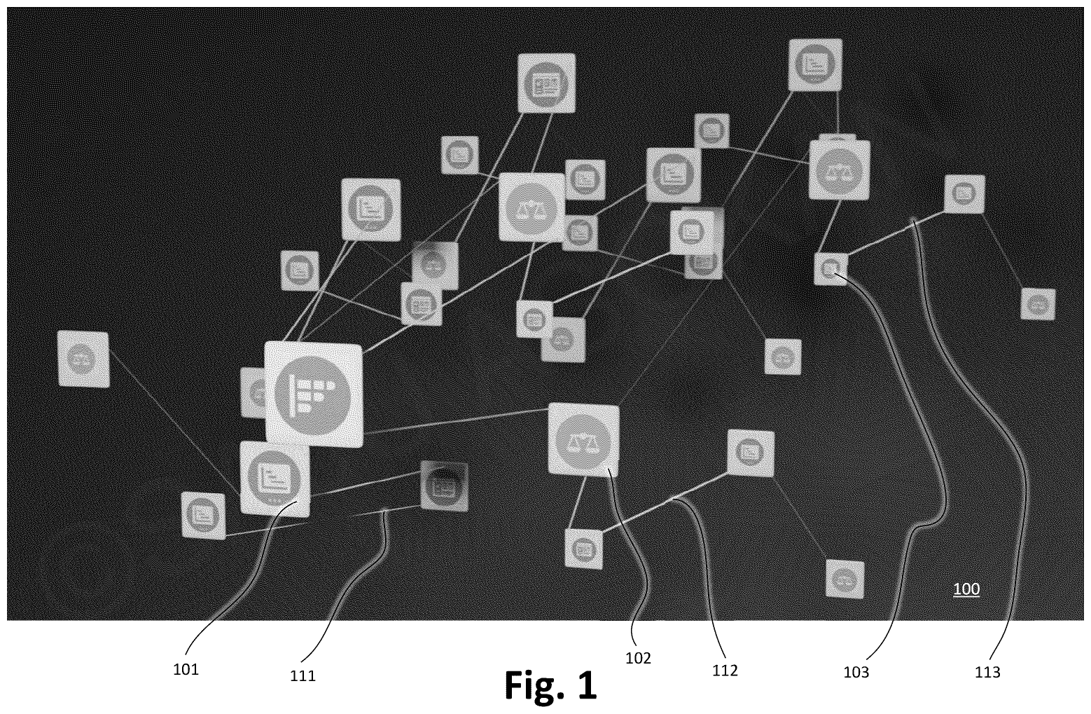

FIG. 1 is an visualization 100 of graph data in accordance to embodiments of the invention. Visualization 100 includes a plurality of vertices 101, 102, 103, etc., each of which is coupled to other vertices via one or more edges 111, 112, 113, etc. As shown, the vertices of graph 100 are represented using small squares with icons inside. Edges of the graph are represented using white lines connecting those vertices. As disclosed, the number of vertices for the entirety of the visualization data can exceed hundreds of thousands or even millions.

In a graph with vertices and edges, such as graph 100, the vertices typically represent the individual points or nodes in the graph. Each vertex may represent a distinct entity or object, such as a city, a person, a web page, or any other type of element that can be defined in the context of the graph.

The edges in the graph represent the connections or relationships between the vertices. For example, if the vertices represent cities, the edges might represent the roads or other transportation routes that connect the cities. In a social network graph, the vertices might represent individuals, and the edges might represent their friendships or other types of connections.

Overall, the vertices and edges in a graph can be used to model a wide range of real-world systems, and the relationships between the vertices can provide valuable insights into the structure and behavior of those systems.

Embodiments spawn layers associated with filters that have been created by a user. Embodiments allow the user to create layers on the fly, and apply filter criteria to each layer. For example, assume that the user wishes to inspect all vertices originating from a selected vertex having a name containing “abc”. As the first step, the user would spawn a new layer (disclosed below) using a context menu. As the layer appears, the user could add conditions by typing it in or dragging and dropping condition elements (e.g., name contains “abc”) from a floating toolbar. Immediately, or nearly immediately, that particular layer would represent the dragged in filter criteria and all vertices that meets the criteria gets attracted and attached to the layer. The user can mix and match multiple criteria by assembling them into the layer. The user can also name the layer with the name of their liking.

The user can repeat this and create as many layers as they want and segregate vertices easily for analysis. Depending on the type or the way a filter is configured, it may automatically apply on layer spawn. For example, a hop count filter could automatically increment the next sequence, or require the user to assemble filter criteria manually.

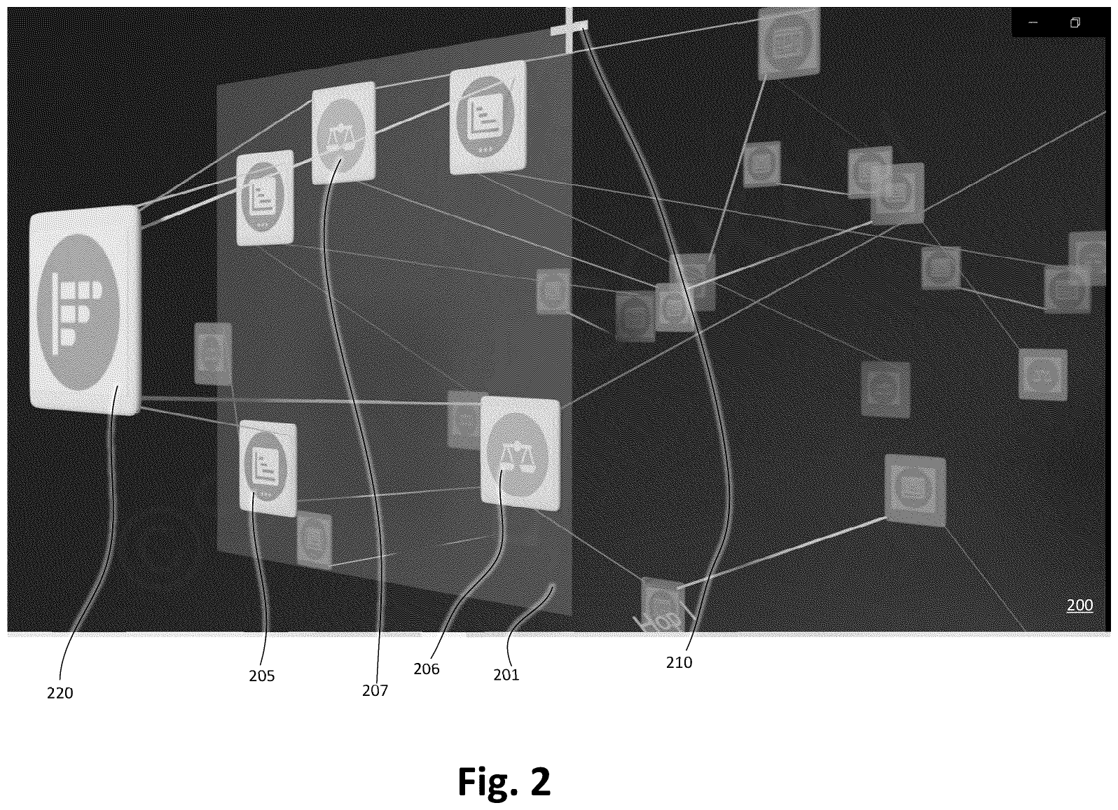

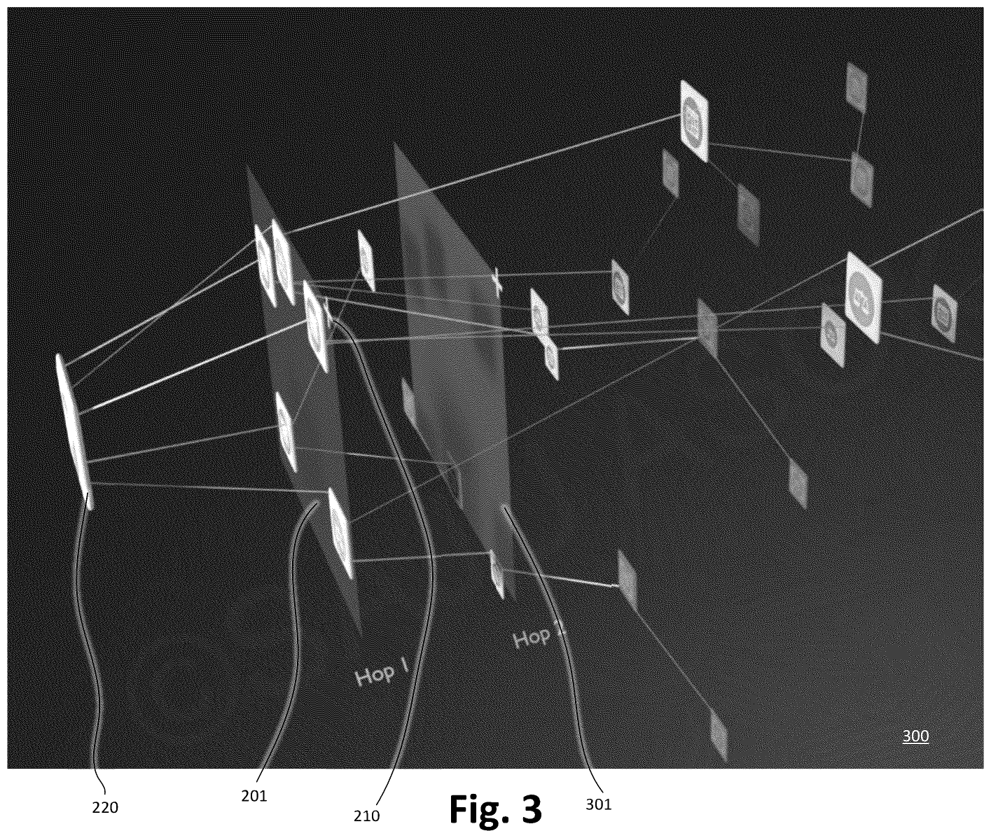

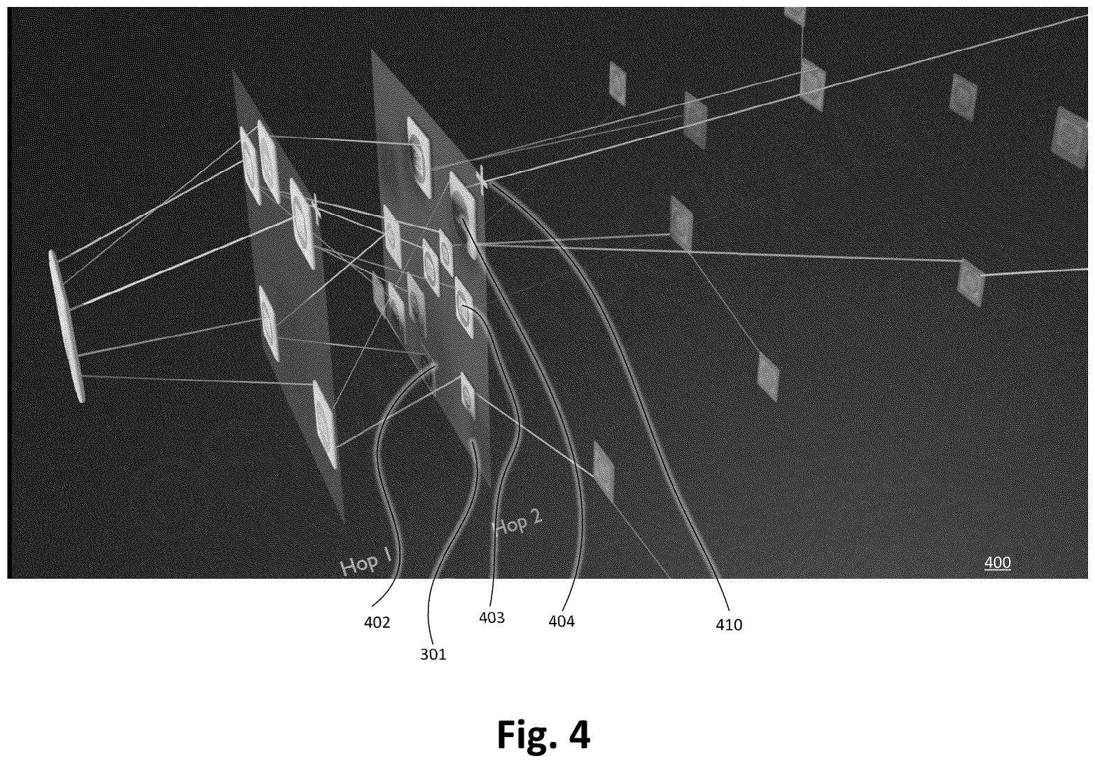

FIG. 2 is an visualization 200 of graph data in accordance to embodiments of the invention. As shown in FIG. 2, the user spawns a first layer 201 by selecting one of the vertices (i.e., vertex 220 or the “source” vertex). Layer 201 is then automatically generated that corresponds to the predefined filter criteria. Vertex 220 moves forward along the Z axis, making room for the hop layers to appear behind it. In the example of FIG. 2, and FIGS. 3-4 below), the filter criteria is hop count, and each subsequent layer increments the hop count by 1. Therefore, layer 201 corresponds to a hop count of 1 relative to vertex 220. Each vertex (e.g., vertices 205, 206, 207, etc.) that meets the criteria of layer 201 (e.g., that are 1 hop for vertex 220) are then graphically moved onto layer 201 as if magnetically attracted.

Each layer has a user interface (“UI”) object, such as plus sign 210 of layer 201, that can be selected by the user to spawn the next layer. The next layer can be generated automatically based on the predefined criteria, or the criteria can be selected by the user when the layer is generated.

FIG. 3 is an visualization 300 of graph data in accordance to embodiments of the invention. As shown on FIG. 3, after the selection of plus sign 210, the next layer 301 that corresponds to hops=2 is generated. FIG. 3 illustrates a timeline of layer 301 being generated but before the corresponding vertices that are 2 hops from source vertex 220 are moved onto layer 301. The newly spawned hop 2 layer 301 immediately starts attracting vertices that are 2 hops away from the source vertex 220 and those vertices gets attached to hop 2 layer 301.

FIG. 4 is an visualization 400 of graph data in accordance to embodiments of the invention. FIG. 4 illustrates a subsequent time to FIG. 3 in which all vertices 402, 403, 404, etc. have been moved onto layer 301. Selection plus sign 410 will then spawn the next layer corresponding to hops=3 in the example of FIG. 4.

FIGS. 1-4 illustrate example embodiments that are applied to a general problem in the graph realm-finding vertices that are a specific hop count away from the vertex of interest. The user can create layers (via a context menu or the +icon) and each layer can be used to represent a particular hop count, which by default would be in an incrementing order. The hop count effectively becomes the layer's filter condition.

If the user needs to inspect more levels of hops, they can quickly create a new layer using the plus button and the (n+1) th layer will spawn. The newly spawned layer attracts the vertices belonging to that hop count and distribute along its XY plane. The hop layer can stretch along the XY plane to make room for more vertices if needed.

The user can type in a hop count and the respective hop layer receives focus. If the layer does not already exist, it gets created and the relevant vertices gets pulled to its XY plane.

The user can dismiss a layer by choosing a layer and hitting Delete or by clicking a close button that the layer provides. Multiple layers can be combined by dragging one onto the other causing the layers to get resized and positioned side by side.

As soon as the previously selected source vertex 220 (i.e., the left most vertex in the FIGS. 2-4) lose focus, the hop layers vanish and the vertices belonging to all hop counts return back to their original position in the graph (i.e., FIG. 1).

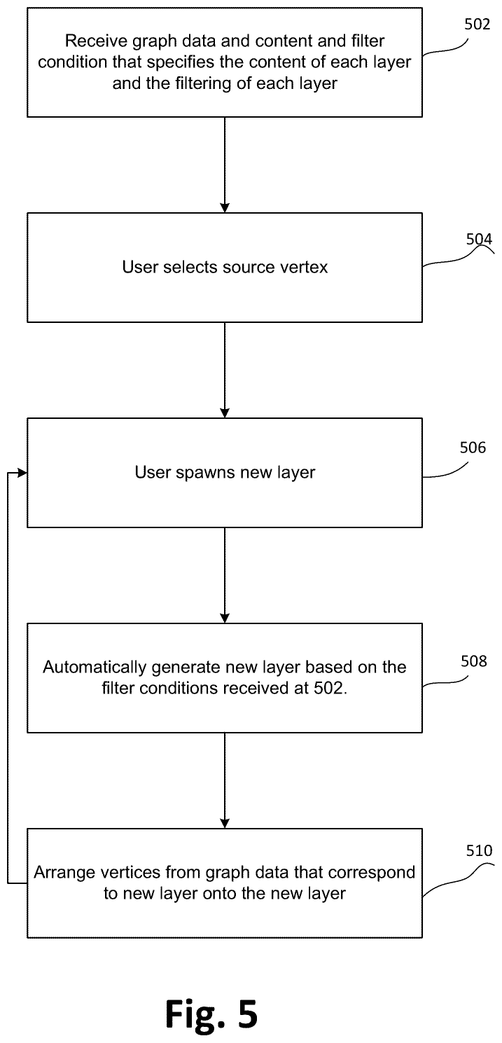

FIG. 5 is a flow diagram of a process for visualizing and filtering graph data for a graph that includes vertices and edges in accordance to embodiments. In one embodiment, the functionality of the flow diagram of FIG. 5 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 502, the graph data, including vertices interconnected by edges is received. Further, at 502, content and filter conditions are received that specify the content of each layer and the filtering of each layer, which can define a pattern. For example, each layer can correspond to a hop (the content) starting at hop=1, and each subsequent layer can increment the hop count by 1 (the filter), such as shown in the example of FIGS. 1-4. Therefore, the first four layers are: Hop Count=1; Hop Count=2; Hop Count=3; Hop Count=4. The filter conditions can be defined by writing expressions, such as by using Regular expressions (“regex”), which are special strings representing a pattern to be matched in a search operation.

In another example, the content may be an age greater than “n”, and the pattern is increment by 5, starting at 20. Therefore, the first four layers are: Age >20; Age >25; Age >30; Age >35.

In another example, the content may be a health care patient, and each layer can be a predefined stage in the diagnosis of the patient, such as (1) screening, (2) doctor visit, (3) blood tests, and then (4) follow up. The layers can be defined as follows: Patient in [Screening]; Patient in [Doctor Visit]; Patient in [Blood Tests], etc.

In other embodiments, no predefined filter conditions are received, and the user can manually enter filter conditions each time a new layer is generated.

At 504, the user selects a source vertex, that functions as the reference vertex for subsequently created layers.

At 506, the user spawns a new layer. It embodiments, the user selects a UI object such as the +plus mark 210 of FIG. 2.

At 508, the new layer is automatically generated based on the filter conditions received at 502. If no filter conditions were received, the user can add conditions to the new layer via, for example, typing it in or dragging and dropping condition elements (e.g., name contains “abc”) from a floating toolbar.

At 510, the vertices from the graph data that corresponds to the new layer, by matching to the corresponding layer filter (e.g., hops=2) is arranged within the layer's X, Y coordinate boundaries. Functionality then continues at 506.

The visualization, such as what is shown in FIGS. 1-4, can be implemented in embodiments using “Three.js”, which is a cross-browser JavaScript library and application programming interface (“API”) used to create and display animated 3D computer graphics in a web browser using WebGL, or by using a real-time 3D engine such as “Unreal”, “Unity”, etc.

One use case for embodiments disclosed above, where the filter conditions are hop count, is from the financials domain. Specifically, in a money laundering analysis scenario, where transactions that are a particular hop count away from the source or that belong to specific categories (e.g., international vs. domestic) can be spatially segregated and visualized. For example, when the user is presented with a graph of all the financial transactions in a bank during a time period and if the user wants to identify those transactions that has exactly four intermediate stages/hops, they can tap four times to create four hop layers and those transactions involving four intermediate stages would get pulled to that respective layer. Alternatively, if the user desires to identify those transactions involving more than five stages, speculating a money laundering case, the user could create a single layer and drag and drop a filter criteria that marks the layer as HopCount >5. This would attract just those transactions having more than 5 intermediate stages or hops into that layer, which helps in easy identification.

Another use case for embodiments disclosed above is from health care domain. Specifically, embodiments would aid in visualizing the patient journey where patients who go through particular stages in diagnosis or treatment can be segregated using filter layers, when the entire graph captures details of numerous patients and their treatment path within a hospital. For example, if each stage of the diagnosis can be marked as a hop, then segregating how many patients complete all the necessary stages of the diagnosis, versus those who drop out, would be easy by creating hop layers. Only those patients who completed that stage/hop would get attracted to the respective layer. Similarly any filter criteria can be mapped to a layer (e.g., patient prescribed scanning and Scanning_stage_date within this_week) and patients can be quickly identified from the vast graph.

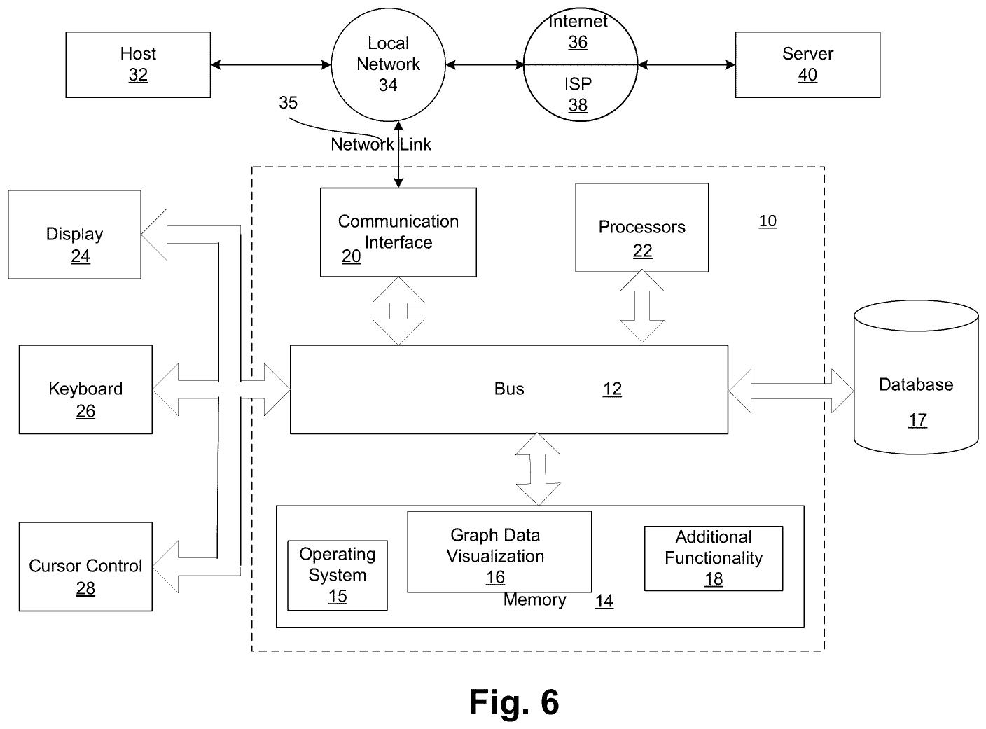

FIG. 6 is a block diagram of a computer server/system 10 in accordance with an embodiment of the present invention that can be used to implement any of the functionality disclosed herein. Although shown as a single system, the functionality of system 10 can be implemented as a distributed system. Further, the functionality disclosed herein can be implemented on separate servers or devices that may be coupled together over a network. Further, one or more components of system 10 may not be included.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a graph data visualization module 16 that performs graph data visualization and filtering, and all other functionality disclosed herein. System 10 can be part of a larger system. Therefore, system 10 can include one or more additional functional modules 18 to include the additional functionality that can utilize graph data visualization and filtering, such as a business intelligence system that uses module 16 to further understand a large amount of gathered/generated data. A file storage device or database 17 is coupled to bus 12 to provide centralized storage for modules 16 and 18, including training data, predefined spend classification categories, etc. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 800, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

As disclosed, embodiments implement layers to display graph data, where the layers act like a magnet into which vertices gets attracted automatically as soon as filters are assembled into the layer by the user. Embodiments assist in solving a data volume issue where the graph would typically have thousands or millions of vertices, such as in a financial transaction, where manually picking and placing vertices would not be possible. The automatic pulling of vertices to respective layers with matching filters solves this data volume issue. The user needs to just define a filter on a layer through the drag and drop of conditions (e.g., hop count >2) and those nodes/vertices that meets the filter condition will automatically assemble in that layer. The user can spawn the next hop count layer on the fly by tapping the +button, or other UI object, upon which a new filter layer spawns with the next incremental filter automatically applied (e.g., previous hopcount+1) and immediately the vertices that belong to the next hop count gets attracted to the new layer, and so on. This helps the user to inspect hop counts sequentially by a simple tap on the +button where the system does layer creation, next sequential filter application and attracting relevant vertices to the new layer. The resulting stack of filter layers would be a sequential arrangement of vertices based on increasing hop counts, all done by the system in response to the user's click on the +button.

Embodiments enable the layered segregation of data in three dimensional space, where the user can add as many layers as needed and apply filters to it. When hop count is applied as the filter, vertices that are a specific hop count away from the selected vertex can be easily identified, even when the graph has millions of vertices. Locating neighboring vertices belonging to a particular hop becomes easy since the vertices with a specific hop automatically gets attracted to the corresponding layer and user just has to look at the hop layer they are interested in. Further layers can be spawned through a simple+icon at the top of the existing layer. This applies to any filter that get assigned to the layers.

In embodiments, since filter layers attract vertices spatially and arrange them along the specific layer's XY plane, users can locate neighboring vertices that meet a specific filter criteria of the user's choice very easily. In the case of a hop count filter, when new layers are spawned, it automatically attracts vertices that are n+1 hops away from the vertex of choice.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of visualizing graph data comprising vertices interconnected by edges, the method comprising:
receiving a selection of a source vertex;
generating a first filtered layer corresponding to a first filter condition relative to the source vertex; and
automatically placing a first plurality of vertices that correspond to the first filter condition on the first filtered layer.

2. The method of claim 1, further comprising:
generating a second filtered layer corresponding to a second filter condition relative to the source vertex;
automatically placing a second plurality of vertices that correspond to the second filter condition on the first filtered layer.

3. The method of claim 1, wherein the first filter condition comprises a predefined pattern relative to the source vertex.

4. The method of claim 1, wherein the generating the first filtered layer is in response to a user request to spawn the first filtered layer.

5. The method of claim 4, wherein the first filter condition comprises an input filter condition provided by a user after the user request.

6. The method of claim 3, wherein the first filtered condition is a hop count relative to the source vertex.

7. The method of claim 6, wherein the predefined pattern comprises incrementing the hop count by a predefined amount for each layer.

8. The method of claim 1, wherein the first plurality of vertices are placed within X, Y coordinates of the first layer.

9. A computer-readable medium having instructions stored thereon, when executed by one or more processors, cause the processors to visualize graph data comprising vertices interconnected by edges, the visualizing comprising:
receiving a selection of a source vertex;
generating a first filtered layer corresponding to a first filter condition relative to the source vertex; and
automatically placing a first plurality of vertices that correspond to the first filter condition on the first filtered layer.

10. The computer-readable medium of claim 9, the visualizing further comprising:
generating a second filtered layer corresponding to a second filter condition relative to the source vertex;
automatically placing a second plurality of vertices that correspond to the second filter condition on the first filtered layer.

11. The computer-readable medium of claim 9, wherein the first filter condition comprises a predefined pattern relative to the source vertex.

12. The computer-readable medium of claim 9, wherein the generating the first filtered layer is in response to a user request to spawn the first filtered layer.

13. The computer-readable medium of claim 12, wherein the first filter condition comprises an input filter condition provided by a user after the user request.

14. The computer-readable medium of claim 11, wherein the first filtered condition is a hop count relative to the source vertex.

15. The computer-readable medium of claim 14, wherein the predefined pattern comprises incrementing the hop count by a predefined amount for each layer.

16. The computer-readable medium of claim 9, wherein the first plurality of vertices are placed within X, Y coordinates of the first layer.

17. A graph data visualization system comprising:
a display;
one or more processors executing instructions and coupled to the display, the processors adapted to:
receive graph data comprising vertices interconnected by edges;
display the graph data;
receive a selection of a source vertex on the displayed graph data;
generate and display a first filtered layer corresponding to a first filter condition relative to the source vertex; and
automatically place and display a first plurality of vertices that correspond to the first filter condition on the first filtered layer.

18. The graph data visualization system of claim 17, the processors further adapted to:
generate and display a second filtered layer corresponding to a second filter condition relative to the source vertex;
automatically place and display a second plurality of vertices that correspond to the second filter condition on the first filtered layer.

19. The graph data visualization system of claim 17, wherein the first filter condition comprises a predefined pattern relative to the source vertex.

20. The graph data visualization system of claim 17, wherein the generate the first filtered layer is in response to a user request to spawn the first filtered layer.
